(19) United States
(12) Patent Application Publication
(10) Pub. No.: US 2018/0065724 A1
(43) Pub. Date: Mar. 8, 2018

(54) SYSTEM AND METHOD OF REDUCING CORROSION IN BALLAST TANKS

(71) Applicants: Mo Husain, Encinitas, CA (US); Gary Shilling, Encinitas, CA (US)

(72) Inventors: Mo Husain, Encinitas, CA (US); Gary Shilling, Encinitas, CA (US)

(21) Appl. No.: 15/803,200

(22) Filed: Nov. 3, 2017

Related U.S. Application Data
(63) Continuation-in-part of application No. 13/815,357, filed on Feb. 25, 2013, now abandoned.

(51) Int. Cl. B63J 4/00; C02F 1/66; C02F 1/76; C02F 1/00

(52) U.S. Cl. CPC B63J 4/002; C02F 1/66; C02F 1/763; C02F 2303/04; C02F 2303/08; C02F 2209/225; C02F 2209/38; C02F 1/008

(57) ABSTRACT

A system and method of reducing corrosion in the ballast tanks of a ship is comprised of a central inert gas manifold extending down into the furthest reaches of the ballast tank, a plurality of lateral gas distribution manifolds extending away from the central manifold, and a plurality of downwardly projecting diffusers connected to the lateral gas distributors that release the inert gas at multiple simultaneous points within the ballast tank space. A method is further presented for using the diffuser array to sparge the ballast water with the inert gas to inhibit microbiological induced corrosion.

### CROSS-REFERENCE TO RELATED APPLICATIONS

This application is a continuation-in-part of application Ser. No. 13/815,357, filed Feb. 25, 2013, entitled “EFFICIENTLY EFFECTIVELY INSERTING INERT GASES INTO THE ENTIRE VOLUMES AND ULLAGE SPACES OF SHIPS' STEEL BALLAST TANKS TO RETARD INTERIOR CORROSION” which is incorporated in its entirety herein.

### FIELD OF INVENTION

The present invention generally relates to the field of mitigation measures for saltwater corrosion of steel hulls of tanker ships. More specifically, the present invention relates to reducing corrosion rates of metal ballast tanks installed in double-hulled, ocean-going ships. Large tanker ships, such as crude oil transporters, are constructed with a plurality of compartments or ballast tanks between the inner and outer hulls. During loading and unloading of cargo, seawater is pumped into and out of these ballast tanks to control the ship's buoyancy. The intermittent flow of seawater and air into and out of these ballast tanks makes the steel they are constructed from particularly susceptible to oxygen-promoted corrosion and biological attack.

### BACKGROUND OF THE INVENTION

Methods of preventing or mitigating oxygen-related and biological corrosion of a ship's ballast tanks can be grouped into three basic categories: 1) steel surface coatings, 2) cathodic protection, and 3) air and seawater treatment. Methods of treating the surface of the steel have involved galvanizing, epoxy coatings, and internal liners. However generally, surface coatings do not maintain their integrity over long periods of time and re-applying the coating is often economically infeasible, especially for ballast tanks which may not be readily assessible. The inherent difficulty of inspecting and repairing surface coatings, over such a large area of steel that is often hidden by the ship's internal structure, makes any coating system an unreliable long-term solution to the corrosion problem. Furthermore, ship fabricators often prefer less effective surface coatings merely because they are thinner and easier to apply as opposed to more effective thicker coatings that might require more labor hours to properly apply, adhere and cure. Studies have also shown that biological activity significantly affects the physical properties of virtually all surface coatings. Micro-cracks and small holes caused by acidic bacteria are commonly found in ballast tanks. Bacterial degradation of surface coatings has been shown to occur in ballast tanks in as soon as 40 days after exposure to seawater microorganisms.

To further stave off corrosion of steel that is exposed to briny seawater after the surface coating fails, ship-owners often install a cathodic protection system. Cathodic protection systems involve installing a sacrificial anode that is electrically connected to the ship steel. The primary corrosion process fundamentally involves an electrochemical reaction between iron and other metallic constituents of the steel and dissolved oxygen. Where seawater and metal come into contact, oxygen dissolved into the briny seawater, gives up electrons that are readily absorbed by the conductive metals that make up the steel. The surface metal atoms that absorb these electrons become solubilized in the brine and react with the ionized oxygen to form an insoluble metal oxide that redeposits back onto the surface of the steel. Another pathway for electrochemical corrosion involves reactions between two dissimilar metal atoms within the steel that are connected through a conductive solution, such as briny seawater. Thirdly, microorganisms within the seawater that adhere to the surfaces of the steel can excrete compounds that also promote and even accelerate electrochemical reactions with the metal atoms of the steel. The sacrificial anode used in a cathodic protection system absorbs electrons donated to the steel and thereby prevents the metal atoms on the surface from solubilizing into the brine and redepositing. Gradually, the sacrificial anode corrodes away and must be periodically replaced. If the anode is not replaced or the electrical connection to the ship's steel is compromised, the cathodic protection system is rendered useless and the accelerated corrosion of the ship's steel quickly resumes. To be an effective anti-corrosion strategy, cathodic protection systems involve special installation, inspection and maintenance procedures. All too often, however, human error and improper care typically render cathodic protections systems an unreliable long-term solution to the corrosion problem.

The third category of anti-corrosion strategies employed by ship owners involves treating the seawater and/or air to reduce the amount of free oxygen exposed to the steel. In one method, the ballast water is pumped into on-shore storage tanks as the ship takes on cargo. As the ship unloads cargo, the stored water is pumped back into the ship's ballasts, thereby eliminating the need for using fresh seawater. This recycled ballast water can be economically treated to remove oxygen and kill microorganisms. Having to treat fresh seawater each time it is introduced into the ballasts would be uneconomical and might be hazardous to the environment if the chemically-treated ballast water or leaked cargo were discharged into local port waters when the ship is loaded. However, not all ports-of-call have an on-shore ballast water storage and pumping system and the ship owner often has no option but to use fresh seawater.

The most common method of treating the air that flows into the ballast tanks when water is pumped out is to purge the space with an inert gas. The inert gases typically employed are “Trimix Gas” from a generator placed aboard the ship. Trimix gas generators intake atmospheric air and produce a gas containing approximately 84% N₂, 12-14% CO₂ with the balance comprising O₂ and Ar (2-4%) by volume. In some older tankers, the inert gas is drawn and scrubbed from the ship's engine exhaust, which is similar to Trimix gas but with a slightly higher O₂ content of around 5% by volume. Inert gas generators are frequently installed on ships since International shipping regulations require the use of an inert gas pad inside the cargo hold when transporting flammable or hazardous substances. Most newer tanker ships use onboard Trimix gas generators as opposed to engine flue gas.

Once the purging system gas design is selected, the next most significant problem involves distributing the inert gas throughout the interior voids of the ballast tanks. A poorly-designed gas distribution system can allow residual pockets of air to remain in relatively stagnant sections of the ballast tank and render the corrosion mitigation effort less effective. Since a typical ship's ballast system design employs different sized ballast compartments spread throughout the ship's hull, ensuring even distribution of the inert gas inside every ballast tank presents a significant challenge to the ship's builders and operating crew. The present invention relates to an improved method for insuring total distribution of the inert gas within the myriad of ballast compartments and when employed with other anti-corrosion strategies, can greatly extend the useful life of a tanker ship.

Previous methods of distributing the inert gas within the ballast tanks during pump out of the ballast water have proven to be largely inadequate because they slow down the maximum rate that water can be pumped out. This effectively slows down the maximum rate at which the ship can take on cargo and extends the time required to fill the interior hull. Furthermore, some previous methods are less preferred because they are difficult to use and require significant maintenance expense. Still, other methods are less preferred because they require generating more inert gas than is needed simply to fill the ballast tank volume. Due to the expense incurred in producing the inert gas, venting excess inert gas into the atmosphere to reach the desired level of deoxygenation within the ballast tanks is a significant economic deterrent. The present invention relates to an improved method of distributing the inert gas within the ballast system while eliminating or minimizing the amount of leakage of inert gas to the environment. The present invention allows the user to reach the desired level of deoxygenation within the ballast tank atmosphere with the least amount of inert gas being used or wasted.

Some existing inert gas distribution methods within the ballast system are too simple to be effective at purging air out of the ballast tanks. In one method, a single pipe discharges inert gas at one point in the bottom of the ballast tank while a second pipe at the highpoint of the ballast tank vents the air being displaced. Computer modeling of this design has shown that up to 2.5 times as much excess inert gas must be moved through the ballast tank to reduce the oxygen content to the desired level. The cost of generating and venting this excess inert gas in addition to the extra time required to prepare the ship for voyage represent a significant economic detriment to the operator. One study found that the operating costs to the shipper of pre-voyage time delays for a large oil tanker can reach as high as $100,000 per year per tanker.

What is needed in the art is a more efficient method of distributing the inert gas into the complex myriad of ballast tanks located throughout a typical tanker ship in the shortest amount of time so that the ship can be protected from corrosion. What is further needed in the art is a ballast tank purging system that utilizes the least amount of inert gas to reach the desired level of deoxygenation within the ballast tank system. What is still further needed in the art is an inert gas delivery system that is not so complicated or maintenance intensive as to deter its use by the ship's crew (which leads to premature failure of ship's hull to corrosion). What is still further needed in the art is an inert gas distribution system that is not subject plugging from sediments that may enter the ballast tanks and settle toward the bottom of the tanks.

In ships fitted with a ballast control system, water is pumped into the ballast tanks when cargo is unloaded and pumped out of the system when cargo is loaded. In many ports-of-call, ballast water is stored in on-shore tanks to minimize the use of fresh seawater during these ballast cycles. Fresh seawater typically contains any number of biological agents capable of accelerating corrosion within the ballast tank system. Fresh seawater also contains higher levels of dissolved oxygen, which can also accelerate corrosion. Recycling the ballast water has a number of beneficial purposes. First, if any material from the cargo hold leaks into the ballast water system, that material can be collected and separated on-shore as opposed to being discharged into the local port waters. Secondly, the ballast water can be pre-treated to greatly reduce its corrosive potential when pumped back into a ship's ballast tanks. Ballast water pre-treatment using typical chemical agents, such as oxygen scavengers and chloramines for biological control, can add significant cost to any ballast water recycling system, which cost is ultimately born by the shipper. Moreover, if a port-of-call does not have an on-shore ballast water recycling system and the shipper must discharge the ballast water into the local port waters, potentially invasive biological species within the ballast water pose a significant threat to the local marine ecology as well as environmental harm from discharging treated water. What is needed in the art is a system onboard the ship that can treat the ballast tank water in-situ to reduce its corrosivity potential and biological activity. In particular, where a ship utilizes engine intering gas recycling as its ballast tank inerting system, what is needed is a system whereby the inherent chemistry of the inerting gas can be used to both deoxygenate and acidify the ballast tank water during pumping. Such a system would reduce and retard oxygen and biological-related corrosion mechanisms within the ballast water, lower the cost of on-shore ballast water treatment, and mitigate the risk of discharging potentially invasive species to the local port waters.

Currently, only four methods have been approved by U.S. Coast Guard authorities for the treatment of ballast water prior to being discharged into local port waters. These systems largely involve known technologies, such as filtration, UV light sterilization, chemical treatment additives, and electro-chlorination or electrolysis. Other methods involving cavitation, thermal treatment and ultrasound are being promoted. One drawback to UV light sterilization is that certain bacteria are known to recover and survive after being exposed to it. For example, some bacteria have been demonstrated the ability to self-repair DNA that is damaged by UV light exposure. Another drawback to UV sterilization is that the ballast water must be substantially clarified prior to exposure to ensure the light penetrates it thoroughly. Another drawback to UV sterilization is that it is generally ineffective against animals, plants, eggs. Onboard chemical and electrolysis systems present additional safety concerns to ship operators. What is needed in the art is a method of treating discharged ballast water that ensures effective destruction of all biological agents without adding significant cost and health and safety issues to the ship operator.

For ships with onboard inert gas generation systems to purge the ballast tanks, the inert gas must be compressed prior to being injected into the ballast system after ballast water pump-out cycles. However, adiabatic gas compression can add over 200° F. to the flue gas temperature exiting the scrubbing system. Hot inerting gas is generally less effective at purging the ballast tanks of cold air pockets due mostly to the density difference between the two gases. Consequently, operators would have to push or flow more hot flue gas through the ballast tanks to achieve the desired level of deoxygenation. Also, higher compression ratios that might increase inerting gas flow rates to the ballast tanks are undercut by the resulting higher flue gas temperature and density difference compared to the cooler air pockets within the tank. What is needed in the art is a flue gas compression and distribution system that also includes cooling the flue gas after compression to move more inerting gas into the tanks and make the flue more effective at deoxygenating the ballast tanks.

### DESCRIPTION OF FIGURES

FIG. 1—A plan view of a tanker ship is shown with a typical cargo and ballast inerting system of the prior art with the equipment and piping modifications of the current invention in bold.

FIG. 2—A schematic of one embodiment of the current invention as adapted to the ballast tank purging system shown in FIG. 1 and including a heat exchanger for cooling the inert gas after compression.

FIG. 3—A cross-sectional view of a typical tanker ship showing on one side the complexity of the ballast compartments and structures between the inner and outer ship hulls and a second side showing an inert gas distribution header of the current invention extending down into the bottom ballast tank area.

FIG. 4—A three-dimensional view of one section of a typical tanker ship hull having the inner tank hull removed and showing inert gas distribution manifold and the plurality of gas diffusers projecting into the plurality of ballast compartments.

FIG. 5—A cross-section view of a typical inert gas injection header with a downward projecting diffuser positions and secured inside a typical bottom ballast tank of a ship.

FIG. 6—A three-dimensional view of a diffuser incorporated in one embodiment of the current invention.

FIG. 7—A schematic of one embodiment of the current invention where a ship's existing inerting gas supply system is modified to incorporate features of the current invention.

### SUMMARY OF THE INVENTION

The present invention presents an improved system for deoxygenating the gases within a ship's ballast tank system by increasing the number of locations within the ballast tank system where the inerting gas is injected. Instead of a single or dual point of injecting the inerting gas into the complex compartmentalization of the ballast system, the ballast tank is fitted with an inert gas distribution manifold throughout to ballast tank system to more uniformly distribute the inert gas into the various compartments of the tank, to speed up the time required and use the least amount of inert gas to reach the desired level of deoxygenation that protects the ship's steel hull from corrosion.

The present invention also presents the use of gas diffusers at each point where the inert gas is injected within the distributed ballast gas manifold. When the ballast system is flooded and being pumped out, the inert gas exiting the diffusers helps stir and suspend any sediments that may have settled within the ballast tanks, allowing their removal with the outflowing ballast water. When the ballast system is dry, diffusers greatly increase mixing of the inert gas with any air that may have been drawn into the pump-out of the ballast water. The use of diffusers for distributing the inert gas within the ballast tank system further reduces the time required and requires less inert gas to reach the desired level of deoxygenation to protect the ship's steel hull from corrosion. In one embodiment, the compressed inert gas is first cooled before being injected into the ballast tanks. The cooler inert gas more easily mixes with any air drawn into the ballast system during pump-out of the ballast water, which also further speeds the time required to reach the desired level of deoxygenation and reduces the amount of inert gas being wasted by venting.

The present invention also presents the use of a distributed network of gas diffusers throughout the ballast system to allow the direct sparging of the ballast water. By sparging the ballast water with an inert gas, CO₂ can dissolve into and slightly acidify the ballast water to aid in killing microbiological activity. Moreover, the inert gas sparging of the ballast water aids in stripping dissolved oxygen within the water, which provides further reduction in corrosivity of the ballast water to the ship's steel hulls. The invention further presents a method and device for adapting the ship's inerting gas system to sparging shore-based ballast storage tanks and floating side-barge tanks for controlling microbiological activity within those vessels prior to the ballast water being pumped back into the ship's ballast system.

The present invention also presents a system for retrofitting an existing ship's inert gas generation system to accommodate the features of the invention.

### DETAILED DESCRIPTION

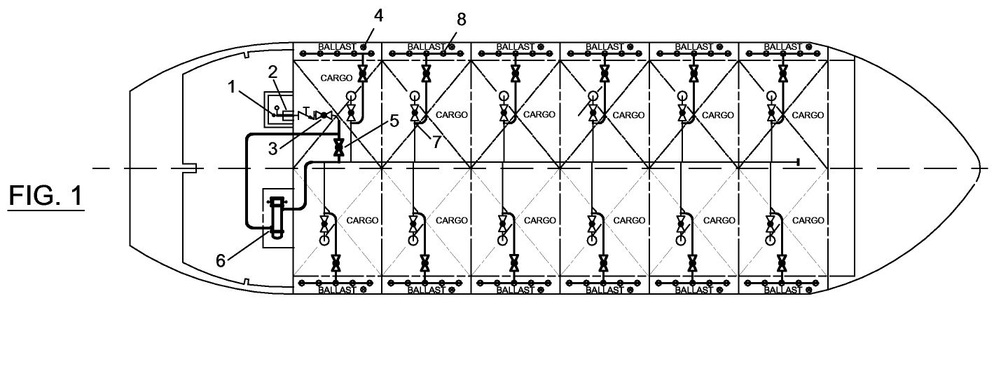

In reference to FIG. 1, a plan view of a typical liquid tanker ship is shown. The inert gas generating system is located below the top deck where an existing distribution manifold 1 extends through a deck seal arrangement 2. A plurality of valves 3 allow operators to deliver the compressed inert gas in the distribution manifold into the cargo holds and into the ballast tanks. Each ballast compartment is fitted with a pressure/vacuum relief valve to protect the compartment's integrity and prevent over/under-pressurization. A new isolation valve 5 is installed and new piping routes the compressed inerting gas over to a heat exchanger 6. The compressed inerting gas can be cooled using air or water pumped from a suitable source. The compressed gas exiting the heat exchanger reconnects to the primary distribution manifold. New branch connections 7 direct the cooled, compressed inerting gas into a plurality of distribution tubes 8 that extend down into the bottom of each ballast tank.

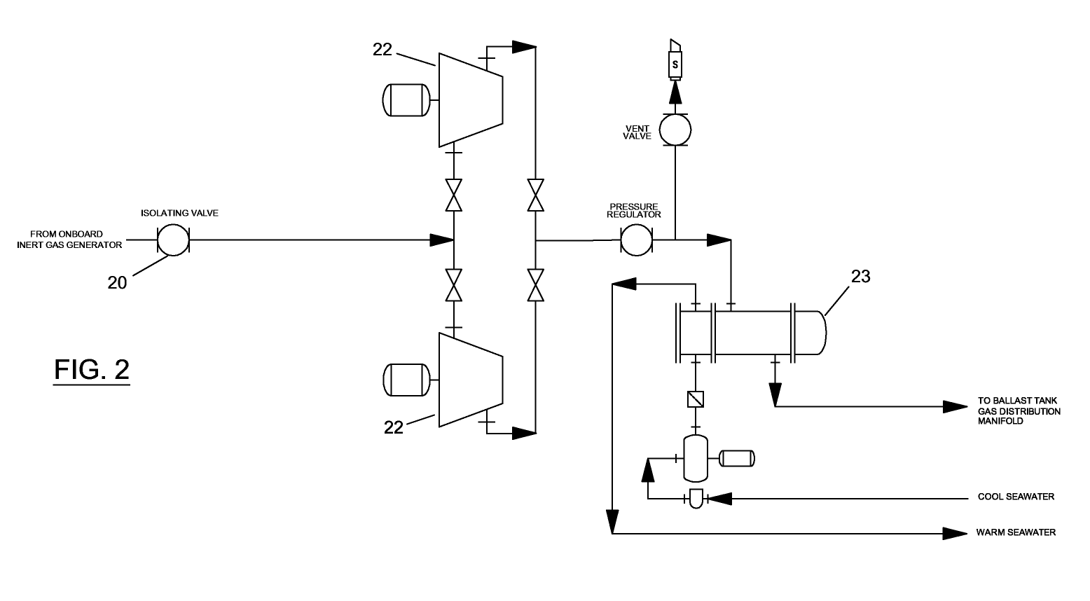

In reference to FIG. 2, a schematic is shown of a modified inert gas booster compression system of the current invention. Inerting gas a ship's existing nitrogen generator flows through an isolation valve 20. A pair of redundant compressors 22 are connected in parallel where typically only one compressor is operated while the other is isolated and idle. Compressed hot inerting gas next flows through additional piping and into a heat exchanger 23. In the embodiment of FIG. 2, the source of cooling is fresh seawater that is strained, pumped and filtered. The warmed seawater then is discharged back into the local waters. In another embodiment, the source of cooling is air circulated by fans across finned tubes carrying the compressed inerting gas. The cooled inerting gas then flows into the ship's existing Inert Gas Supply (I.G.S.) distribution system.

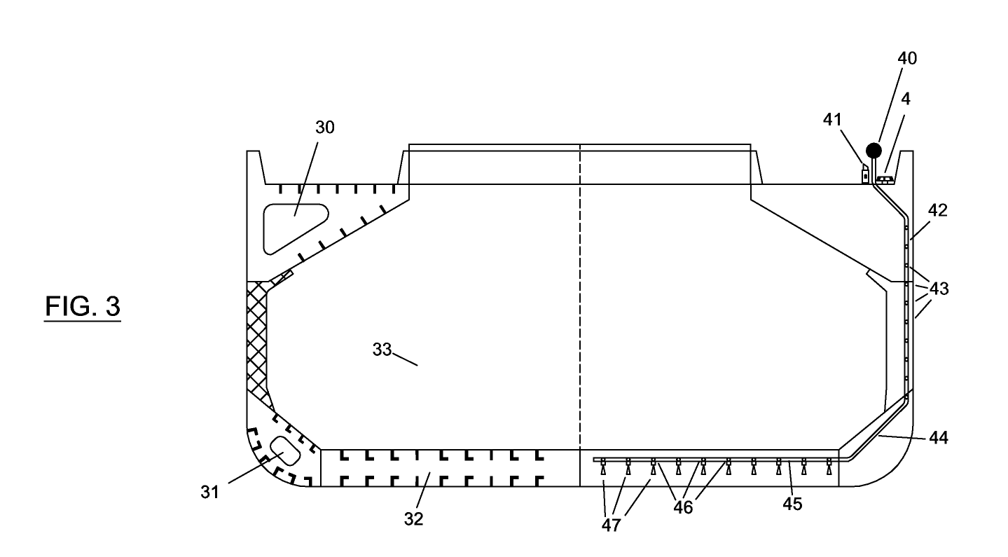

In reference to FIG. 3, a cross sectional view of a typical midship ballast tank is shown. The topside ballast tank 30, a hopper tank 31 and a double-bottom tank 32 are all in communication to form a continuous ballast tank system bordering either side of the main cargo hold tanks 33. During the ship's construction, various steel members are welded to the outer side of the cargo hull to reinforce the inner hull. This cargo hull reinforcing steel projects raised surfaces into the ballast tank space, which creates a complex array of interconnected compartments within the ballast tank system. The complex geometry of the ballast tank space further exacerbates the inerting process by inhibiting the free-flow pathway of the purge gas. In one embodiment of the current invention, a common inert gas downpipe 40 is connected to the main I.G.S. distribution manifold. One or more ballast purge vents 41 ports extend above the ballast tanks where air or inert gas can be vented when ballast water is being pumped into the tanks. When ballast water is pumped out of the tanks, air typically is drawn back into the ballast tanks through these vents and must be subsequently purged out of the ballast tank with the inerting gas. Excess inert gas that flows into the ballast tank is vented back out. These vent ports provide a relatively easy point to measure the oxygen content. Once the oxygen level of the vented gas reaches the desired level, the operator can shut off the inerting gas valve and cease flow. In one embodiment of the current invention, the inerting gas flow rate into the ballast tank equals or is slightly higher than the rate water is pumped out such that air is prevented from re-entering the ballast tanks through the exhaust vents.

In continued reference to FIG. 3, the inert gas distribution system inside the ballast tank is comprised to one or more vertical pipe sections 42 with each vertical pipe section having a plurality of lateral pipe sections 43 evenly distributed throughout the sidewall of the ship. An angled section 44 extends from the vertical pipe section over to a horizontal pipe section 45. The horizontal pipe section also has a plurality of laterals 46 evenly distributed throughout the channels of the double-bottom ballast tanks. Projecting downward from the plurality of laterals are a plurality of diffusers 47 through which the inert gas passes into the ballast tank space. The diffusers are pointed downward to aid in the stirring of sediments so that they remain suspended within the exiting ballast water and do not collect within the bottom of the ballast tank.

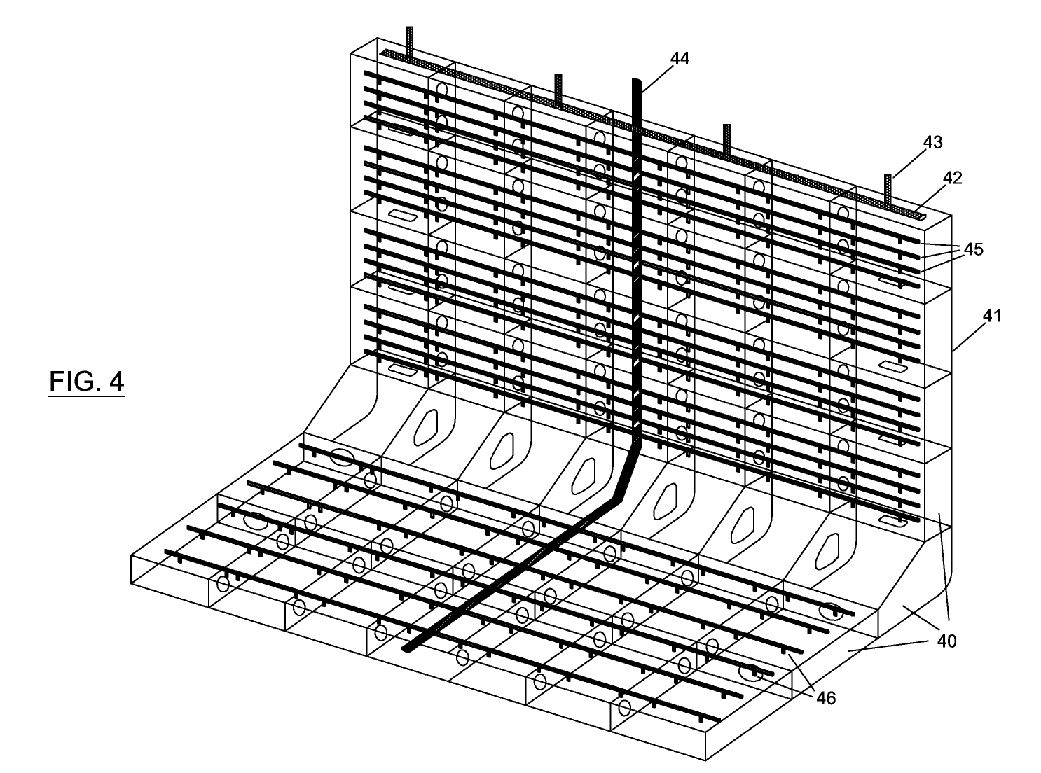

In reference to FIG. 4, a 3-dimensional cross section of the outside hull and ballast tank system of a typical double-hull tanker ship is shown with an embodiment of the current invention installed. A plurality of ell-shaped reinforcing bulkheads 40 are attached to the exterior hull steel wall 41. Once the inner steel hull is cladded to these rib sections, a plurality of ballast compartments is formed. Holes are located at multiple points within the bulkheads 40 so that ballast water can readily flow throughout the plurality of ballast compartments. A typical tanker ship will have several groups of these ballast systems connected together to form the ship's ballast control system. Each ballast tank has a vent header 42 that collects gases that are being purged out of each ballast compartment. One or more vent points 43 project above the upper deck of the ship. A distribution manifold 44 is connected to the ship's main I.G.S. header. In one embodiment, the plurality of laterals extends through separate holes bored into the reinforcing ribs such that the flow distribution holes are not impeded. Extending downward from the laterals inside each of the ballast compartments, one or more diffusers 46 are connected to the horizontal pipes 45 that inject the inerting gas directly into each ballast compartment.

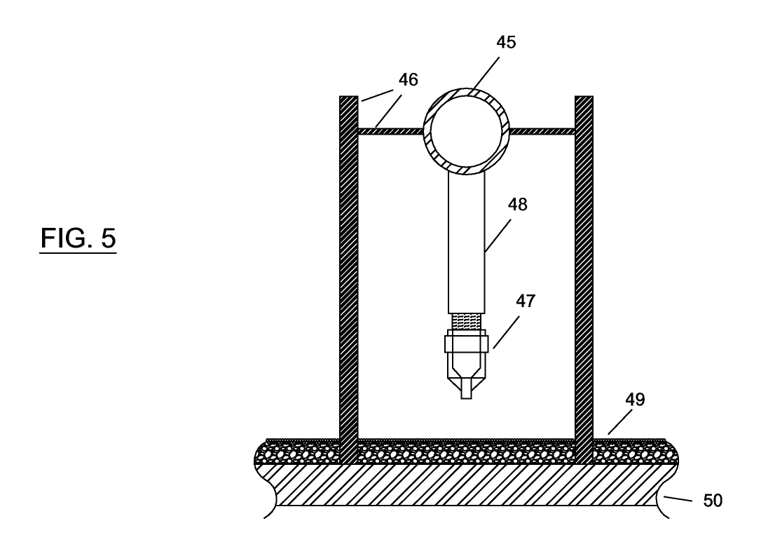

In reference to FIG. 5, a cross sectional view of one of the horizontal pipes 45 extending into one of the double-hull bottom ballast tanks is shown. The horizontal pipe is suspended above the floor of the compartment by pipe supports 46. Extending below horizontal pipes, a threaded diffuser nozzle 47 is in communication with the inerting gas flowing through the horizontal pipes through a threaded pipe nipple 48. In this embodiment, a layer of sediment 49 is shown settling atop the bottom steel hull 50. In this orientation, the sediments are less likely to plug the diffuser's gas discharge opening and as the inerting gas flows into the bottom ballast tanks, stirring of the sediments is promoted. The suspended sediments are more easily removed from the tanks with the outflowing ballast water. Depending on the size of the ballast tank, one or more of these downwardly projecting diffusers can be attached to the horizontal pipes. In one embodiment, two diffusers are installed on the horizontal pipes and evenly spaced apart within each bottom ballast tank.

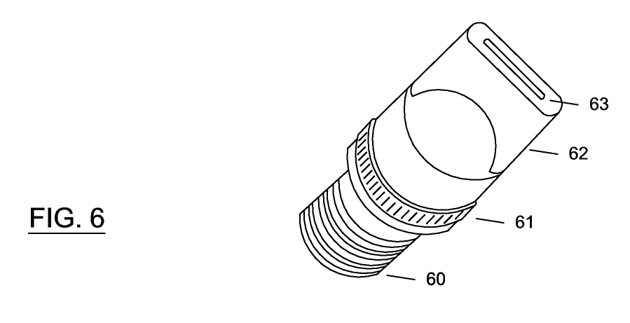

In reference to FIG. 6, a diffuser of one embodiment of the invention is shown. The diffuser has a threaded male fitting on one end that is fastened to a matching threaded female fitting on the inerting gas piping. A gripping section 61 allows the use of standard tools to secure the diffuser into the piping fitting. The diffuser has a converging nozzle 62 that accelerates the inerting gas toward the discharge slit 63. In this embodiment of the invention, pressure losses in the inerting gas piping are minimized by keeping the gas velocities relatively low. However, at the diffuser, the gas velocity is greatly accelerated so as to provide the greatest stirring and mixing action in the environment around the diffuser. When the ballast tanks are flooded with water, the accelerated inert gas stirs sediments so they can be removed with the outflowing ballast water. When the tanks are empty of ballast water, the accelerated inert gas exiting the diffuser greatly improves the rate of mixing and purging of the oxygen within the tank gases, which allows the ballast tanks to be deoxygenated to the desired level in a much shorter time than conventional inerting gas systems.

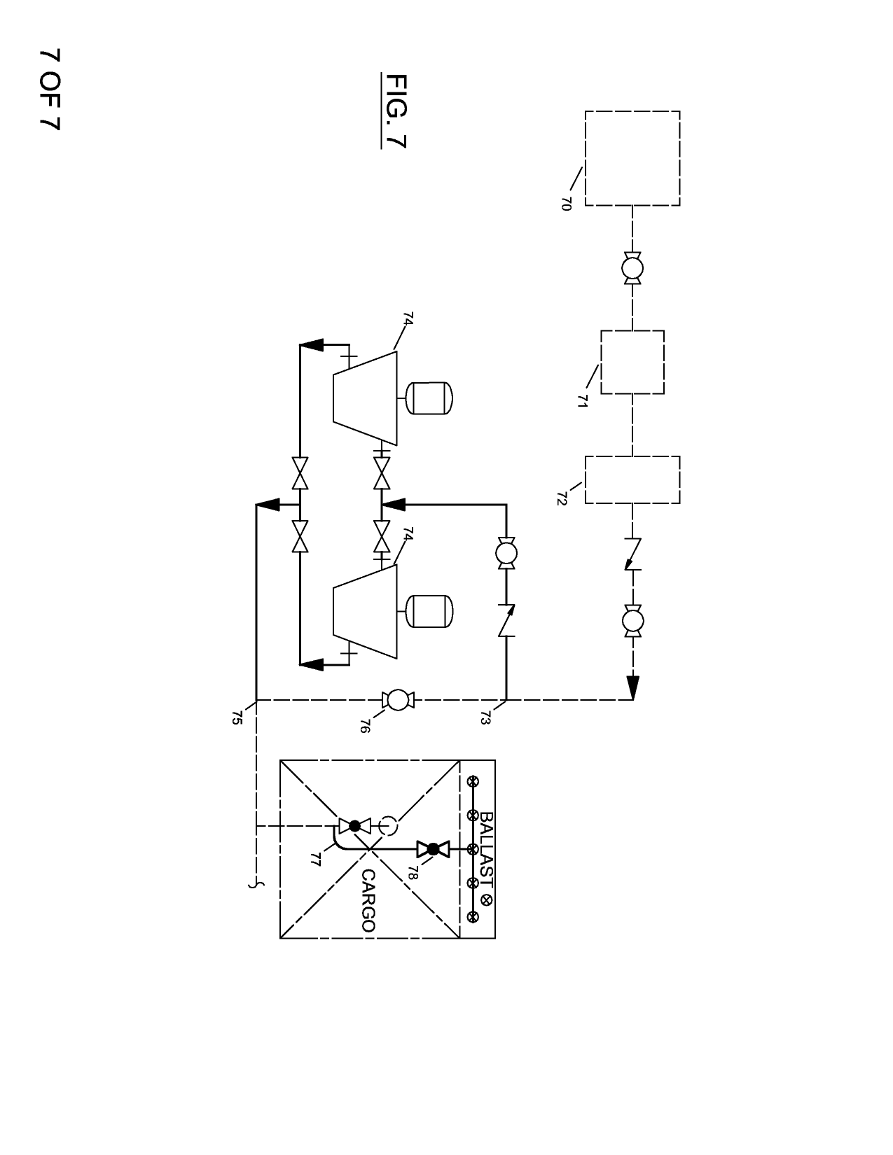

In reference to FIG. 7, a schematic of a ballast inerting system of the current invention is shown being retrofitted to an existing I.G. System (IGS) aboard a typical tanker ship having a ballast control system. Because the diffusers greatly accelerate the inert gas at the point of release into the ballast compartments, the pressure loss under flowing conditions can be quite high. In one embodiment, the required gas pressure upstream of the diffuser is up to 60 prig. Since conventional IGS delivery systems do not employ a distributed array of diffusers positioned throughout the ballast tanks, the existing inert gas compressors would not provide sufficient pressure to overcome the diffuser pressure loss and any additional pressure losses incurred under flowing conditions. Consequently, in the embodiment of the current invention, new gas compressors will have to be provided to provide the required gas pressure under flowing conditions. A typical tanker ship IGS includes an inert gas generator or source 70. If the inert gas is engine exhaust, the gas will pass through a gas scrubber 71 to remove contaminants. The inert gas then passes up to the deck of the tanker ship through a deck seal 72. The suction piping to the new gas compressors 74 ties into the existing above deck IGS piping at 73. The discharge piping from the new gas compressors 74 ties into the ship's main IGS header at 75, which is downstream of an isolation/bypass valve 76. A typical tanker ship has a plurality of individual cargo hold tanks that are each connected to the IGS header to deliver inerting gas to the head-space above the cargo. In one embodiment of the current invention, the ballast tank inerting gas connects to the cargo inerting header upstream of the control valve at 77. A second ballast IGS control valve 78 is provided to isolate the ballast system from the IGS system. The valves controlling the flow of inerting gas either to the cargo hold or the ballast system can be fully automated with electronic or pneumatic actuation, or can be manually actuated, or some combination of the two depending on the level of automation desired by the ship owner/operator.

The present invention particularly concerns progressively and sequentially blowing a relatively cool inerting gas through diffusers, having sufficient flowing gas pressure drop to remedy any clogging by sediments, into the entire volume of a double hull tanker's ballast tanks to retard corrosion in the interior of the ballast tanks. Furthermore, the diffusers in the bottom ballast tanks inject the inerting gas downward onto the floor of the hull to stir up sediments so they can be removed from the ballast tanks during periodic pump-out of the ballast water. Furthermore, the present invention concerns sparging the ballast water stored in the ballast tanks, on-shore tanks, or side-floating tanks through an array of diffusers with an inerting gas to ‘kill’ aquatic nuisance species.

By extending the points of inert gas injection also into the side walls of the ballast tank, fewer air pockets will remain in the upper ballast tanks, where often the worst corrosion occurs compared to prior art systems. By installing a plurality of symmetrically arranged inert gas injection points within the ballast tank, greater operational flexibility can be achieved. In one embodiment, a low flow of inert gas is injected for a short period of time to allow a more subtle air purging rate that better renders difficult-to-reach spaces at least partially deoxygenated while using a lesser amount of inert gas. After this initial injection period, the inert gas flow may be accelerated in steps over time until the vented gas reaches the desired level of deoxygenation. By using diffusers at each point of injection, as the flow rate of inert gas increases, better distribution of the inert gas within the ballast tank space is achieved. Because using diffusers increases the pressure drop of the inert gas being injected into the ballast tank, higher output pressure compressors will need to be employed for use with the current invention. Since higher compression ratios result in excessive heating of the inerting gas, cooling the gas prior to entering the ballast tank brings the inerting gas' density closer to that of the air it will be displacing and mixing efficiency is greatly improved. During sparging of the ballast water, the cooler inerting gas also creates better bubble distribution at the outlet of the diffusers. By increasing the pressure of the inert gas, diffusers with smaller outlet slits can be used, which are less likely to allow ingress of sediments that could plug the diffuser and are more effective at creating sparging bubbles when gas is injected into the ballast water for deoxygenation and microbial corrosion mitigation. When sparging the ballast water, a higher inerting gas pressure is also required to overcome the static head of the ballast water within the tank. For inert gas compressors requiring 20 psi for the diffuser pressure drop and up to 40 psi for the static head of the ballast water, compressor discharge pressures of up to 60 prig are required. At this compression ratio, the inerting gas could leave the compressor at over 130° F., which would greatly benefit from cooling prior to injection into the ballast tank during deoxygenation of the ballast air space. Since many existing ship, barge or on-shore inert gas generators cannot generate the outlet pressures required for adequate flow through the diffuser array of the current invention, gas booster compressors may be required to be installed downstream of the inerting gas generator.

The present system uses inert gas to sparge the ballast water (i) to retard interior corrosion in ballast tanks of a double hulled tanker (ii) to “kill” harmful aquatic nuisance species in ballast water of double hulled tanker, and (iii) killing of organisms in shore based tanks or in shore-side floating tanks. The diffuser array for the ship ballast tanks, onshore tanks, or side-floating tanks are symmetrically distributed near the bottom of the tanks. The diffuser array is also symmetrically distributed throughout the side walls of the ship's ballast tanks. The number of diffusers and their location within the tanks are based on each tank's particular design layout.

A computer system controls the inert gas feed valves at each different level within the tank according to (1) the relative gas density and temperature differences between the inert gas being introduced into a tank and the ambient gas or air currently in the tank, (2) the rate of inert gas flow relative to tank capacity (at each successive level), and (3) a time sequence by which the lower regions of the tank are progressively first inerted, pushing the air upwards and out through vents at the top of the tank. During air purging cycles, as the level of deoxygenation progresses within the ballast tank, the control system can adjusts the flow of inerting gas at each level of the horizontal laterals branching off of the central injection header to minimize the amount of inerting gas needed and shortening the amount of time required to achieve the desired oxygen levels.

Using the same array of inert gas injection diffusers for deoxygenating the space of the empty ballast tank, the current invention employs in situ sparging of the ballast water within the ballast tank to kill harmful organisms. When a low-oxygen inerting gas is sparged into the ballast water, the ballast water becomes deoxygenated (hypoxia) and detrimental to aerobic marine life survival. When a high-CO₂ inerting gas is sparged into the ballast water, the ballast water's pH is acidified due to dissolution of CO₂ into the water and the formation of carbonic acid HCO3— (hypercapnia). Acidification of the ballast water is detrimental to both aerobic and anaerobic marine life survival. One objective of the current invention is to use the commonly available marine inerting gas generators to change the chemistry of the ballast water to destroy aquatic nuisance species and to mitigate corrosion from other microbiological agents within the ballast system.

In one embodiment of the invention, dissolved O₂ concentrations in the ballast water were reduced to 10% saturation and the pH was reduced to 5.5 after 10 minutes of sparging with the Trimix inerting gas. All organisms except of Vibrio cholerae showed no mortality in aerobic conditions. The shrimp and crabs incubated in “trimix” were dead after 15 minutes and 75 minutes, respectively. Even a transfer into aerated water did not result in any movement. The brittle stars incubated under nitrogen started to move again after transferred into aerated water. The shells of all the mussels sparged with the Trimx inerting gas were open (indicating mortality) after 95 minutes. Mortaility of the barnacle species were also confirmed after 95 minute sparging with the Trimix gas. Mortaility of plankton copepods was confirmed after only 15 minutes of sparging with the Trimix inerting gas.

By sparging the ballast water with readily available trimix gas found on most ships to cause hypoxia and/or hypercapnia, a substantial variety of marine organisms will be destroyed. In most cases where the ballast water is sea water, trimix gas will eliminate the need for addition of biocides or other chemicals. However, where the ballast water is fresh water, the extent of acidification caused by the trimix gas sparging is slightly reduced and some addition of a biocide, such as chlorine dioxide or chloramine, may be necessary to achieve the level biological mortality required. In one embodiment of the current invention, the ballast water is sparged with the trimix gas until the dissolved CO₂ is at least 50 ppm. In one embodiment of the current invention, the ballast water is sparged with the trimix gas until the dissolved CO₂ is at least 20 ppm. In one embodiment of the current invention, the ballast water is sparged with the trimix gas until the dissolved CO₂ is at least 500 ppm The CO₂ level is increased to achieve a sufficient level of marine biological mortality. In another embodiment, the ballast water is sparged by the trimix gas until the level of dissolved oxygen less than ≦0.8 ppm to achieve a sufficient level of marine biological mortality. In another embodiment, the ballast water is sparged by the trimix gas until the pH is lowered to at least 6.0 to achieve a sufficient level of marine biological mortality.

In one embodiment, the device kills all aquatic nuisance species (ANS) in the entire volume of ballast water in a shore based tank or in shore side floating tanks, such as in a barge or in converted ships, specifically designed to receive polluted ballast water. Of particular concern is ballast water treatment for ballast water temporarily contained in shore based tanks or shore side floating tanks, such as in a barge or in a converted ship by infusion and diffusion of inert gas into ballast water and elevated CO2 and simultaneously adding mild chlorine without harming the ballast water discharge. The ballast water can be diffused through special diffusers such that ingress of sediments in the diffuser is nearly impossible.

The following table presents the flow rates, capacity requirements and dimensional requirements for an onshore ballast water treatment system for 24-hour capacities ranging from about 1,000 cubic meters per day to around 15,000 cubic meters per day. Values are expressed in a range of units to facilitate use of the table elements.

The table presents the rates of continuous flow of water for the processing facility, sizes of the processing structure, and size of holding facilities needed. For example, an onshore ballast water treatment facility for processing 10,902 cubic meters per day requires a square processing facility with 160 feet per side. The capacity to hold 10,902 cubic meters of water can be provided by a round tank or comparable pond 10 feet deep with a radius of 110.7 feet.

DESIGN OF ON-SHORE BALLAST WATER TREATMENT FACILITY FOR
CAPACITIES FROM 1090.2 TO 14,172.6 CUBIC METERS PER DAY

| | Rate of Continuous Flow Water Treatment | | | | | | |
|---|---|---|---|---|---|---|---|
| | At 2 hours water treatment rate | | | | | | |
| Rate of | Per Minute | Gallons | 200.0 | 800.0 | 1,400.0 | 2,000.0 | 2,600.0 |
| Continuous | | Cubic feet | 26.7 | 107.0 | 187.2 | 267.4 | 347.6 |
| Flow of | | Cubic meters | 0.8 | 3.0 | 5.3 | 7.6 | 9.8 |
| Water to | Per Hour | Gallons | 12,000.0 | 48,000.0 | 84,000.0 | 120,000.0 | 156,000.0 |
| Be Treated | | Cubic feet | 1,604.3 | 6,417.1 | 11,229.9 | 16,042.8 | 20,855.6 |
| | | Cubic meters | 45.4 | 181.7 | 318.0 | 454.2 | 590.5 |
| | Per Day | Gallons | 288,000.0 | 1,152,000.0 | 2,016,000.0 | 2,880,000.0 | 3,744,000.0 |
| | | Cubic feet | 38,502.7 | 154,010.7 | 269,518.7 | 385,026.7 | 500,534.8 |
| | | Cubic meters | 1,090.2 | 4,360.8 | 7,631.4 | 10,902.0 | 14,172.6 |
| Size of | Size of | Square Feet (8 foot height) | 400.0 | 1,600.0 | 6,400.0 | 25,600.0 | 102,400.0 |
| Processing | Square | Square Meters (2.44 meters height) | 37.2 | 148.6 | 594.6 | 2,378.3 | 9,513.3 |
| Structure | Processing | Feet per side | 20.0 | 40.0 | 80.0 | 160.0 | 320.0 |
| | Structure | Meters per side | 6.1 | 12.2 | 24.4 | 48.8 | 97.5 |
| Size of | Size of | Square Feet (10 foot height) | 3,850.3 | 15,401.1 | 26,951.9 | 38,502.7 | 50,053.5 |
| Holding | Circular | Square Meters (3.05 meters height) | 357.7 | 1,430.8 | 2,503.9 | 3,577.0 | 4,650.1 |
| Facilities | Holding | Radius in feet | 35.0 | 70.0 | 92.6 | 110.7 | 126.2 |
| | Facility | Radius in meters | 10.7 | 21.3 | 28.2 | 33.7 | 38.5 |

The above table illustrates a range of design parameters, recognizing that the capacities described can be scaled up to accommodate the largest of requirements. The onshore ballast water treatment system must be custom designed for each port with the driving design element being the maximum amount of discharged untreated ballast water that must be a accommodated each day. This element can be determined by considered the number of ships in port, amount of cargo they will be loading and the amount of time it will take to load the cargo.

Testing Methods.

Three parallel incubations were done for each experiment. Several organisms were incubated in 1.5 L of seawater at 22° C. in large Erlenmeyer flasks. Each incubation was equilibrated with the respective gas using aquarium stones before any organisms were introduced. The aerobic control was bubbled from an aquarium pump for approximately 15 min and left open to the atmosphere after addition of specimens. An anaerobic incubation was bubbled with 99.998% nitrogen for 15 min. After introduction of the organisms, the bubbling was continued for another 10 min and then the container was closed with a rubber stopper or the bubbling was continued. The incubation in trimix was treated similarly except that the gas mix was used instead of nitrogen. The oxygen concentrations were measured after the initial bubbling period using a Strathkelvin oxygen electrode with a Cameron instruments OM-200 oxygen analyser. Ph values were determined using a combination electrode and a Radiometer pH meter.

Survival of the specimens was determined visually by checking for motile responses to tactile stimulus (e.g. mussels do not close their shells, barnacles to not withdraw their feet, shrimp do not move their mouthparts, worms appear limp and motionless). After each testing of the animals, the incubation flasks were bubbled for 10 min to reestablish original conditions. To verify survival of the specimens, they were relocated to aerobic conditions and checked again after 30 min. If they still did not respond, they were considered dead. The survival of the bacterium Vibrio cholerae strain N16961 was monitored by repeated plating on Luria-Bertani Agar with Rifampicin (100 μg/mL). This setup allowed us to compare responses to nitrogen and “trimix” while making sure that test specimens were not gravely affected by other experimental parameters. Incubation in pure nitrogen allow for a comparison with published results by others.

The oxygen concentrations were measured at “non-detectable” for the nitrogen incubations and 10% air saturation (=16 Torr partial pressure) for the “trimix”. The pH value of the water bubbled with trimix reached 5.5 after the initial 10 min of vigorous bubbling. The aerobic and nitrogen bubbled seawater maintained their pH at 8. The incubations showed clearly that “trimix” kills organisms considerably faster than incubations in pure nitrogen Table 1. All organisms except of Vibrio cholerae showed no mortality in aerobic conditions. The shrimp and crabs incubated in “trimix” were dead after 15 min and 75 min, respectively. Even a transfer into aerated water did not result in any movement. The brittle stars incubated under nitrogen started to move again after transferred into aerated water. All the mussels incubated in nitrogen and “trimix” were open after 95 min but only the ones in nitrogen still responded to tactile stimuli by closing their shells. The barnacles were judged dead after incubation in “trimix” when they did not withdraw their feet when disturbed, the ones incubated in nitrogen still behaved normally. The plankton sample mainly contained copepods. They stopped moving after 15 min and could not be revived in nitrogen and “trimix” incubations. The results are summarized below.

| | | Number/ | | | |
|---|---|---|---|---|---|
| Species | | incubation | Nitrogen | Trimix | Comments |
| Mimulus | Crab | 7/inc | Normal | Dead after | |
| foliatus | | | | 75 min | |
| Mytilus | Mussel | 10/inc | Open but | 6 dead after | |
| californianus | | | responding | 95 min | |
| Pollicipes | Barnacle | 10/inc | Normal | Dead after | |
| polymerus | | | | 60 min | |
| Megabalanus | Barnacle | 5 | Dead after | Dead after | |
| californicus | | | 84 h | 48 h | |
| Sebastes | Rockfish | 2 | Dead after | Dead after | |
| diplopora | | | 19 min | 7 min | |
| Ophionereis | Brittle | 5-10 | Most survive | Most survive | Mean of 4 |
| annulata | star | | up to 3 h, | up to 3 h, | experiments |
| | | | most dead | several dead | |
| | | | after 26 h | after 26 h | |
| Ophioderma | Brittle | 8/inc | Not moving but | Dead after | |
| panamanse | star | | revivable by air | 50 min | |
| Unidentified | Caridean | 6 | Affected but | Dead after | |
| | shrimp | | alive after | 25 min | |
| | | | 30 min | | |
| Unidentified | Caridean | 6 | 2 dead after | 5 dead after | |
| | shrimp | | 30 min | 45 min | |
| Mysolopsis | Mysid | 25 | Dead after | Dead after | |
| californica | shrimp | | 15 min | 15 min | |
| Lysmata | Shrimp | 10/inc | Normal | Dead after | |
| californica | | | | 20 min | |
| Plankton | Var. | lots | Dead | Dead after | |
| mix | copepods | | | 15 min | |
| Tigriopus | Copepod | 8-10 | Dead after | Many dead | Mean of 3 |
| californicus | | | 2 h | after 2 h | experiments |
| Vibrio | Bacterium | 2.5 × 10⁶/ml | >>99% dead | >>99% dead | Aerobic: |
| cholerae | | | after 24 h | after 24 h | 30% dead |
| | | | | | after 24 h |

Two effects have to be distinguished when looking at “trimix” incubations in seawater: a) the lowering of the pH from pH 8 to about 5.5 and b) the raised CO₂ concentrations in the water. While the pH change caused by the incubations in “trimix” are in the range of published experiments, the CO₂ concentration in “trimix” (about 14%) is much higher than those investigated in the published literature (0.1% to 1%). Therefore, the effects of “trimix” incubations should be much stronger than those published previously.

The trimix combines two effects on organisms—hypoxia and hypercapnia. Preliminary results demonstrate the effectiveness of this combination in quickly killing a variety of sample organisms. Contrary to methods using additions of biocides or any chemicals in general, nothing is added to the ballast water and, therefore, nothing will be released into the environment when it is released again. Methods using radiation, heating, or filtering ballast water before or during a ship's trip, are much more expensive. The equipment needed to establish a rapid gassing of ballast water is available off the shelf and has been used in the marine environment. The plumbing and gas release equipment has been optimised and has been used in application such as aquaculture, sewage treatment and industrial uses. Extensive supporting literature and research about the design and optimisation of equipment for the aeration of water is available from public resources. Inert gas generators are available for fire prevention purposes on ships and other structures and are already installed on many ships, mainly tankers. They can use a variety of fuels including marine diesel to generate the inert gas.

In order to increase the efficacy of the Trimix mentioned above, especially regarding microorganisms, we can optionally add an additional agent to the treatment, the gas chlorine dioxide (CLO₂). Chlorine dioxide is a compound that is widely used since the early 1900s for a variety of commercial water treatments including disinfections of pool water, waste water, and drinking water (see e.g. “Chlorine Dioxide”, EPA Guidance Manual, chapter 4, EPA 815-R-99-014, 1999). The concentration of chlorine dioxide in drinking water treatments is between 0.2 and 2 ppm, in other applications the concentration varies depending on the degree of contamination. It is usually added to the water to be treated as a solution in water (typically in concentrations up to 1%) or, if needed in large quantities, is generated on site through commercially available generators (e.g., EVOQUA Water Technologies, 210 Sixth Ave, suite 3300, Pittsburgh, Pa. 15222, USA; WWW.evoqua.com). The chemical reactions caused by the addition of CLO₂ to the system described earlier are:

CO₂+H₂O→H₂CO₃ [symbol] H⁺+HCO₃⁻

CLO₂+e⁻→CLO₂⁻

CLO₂⁻+4H⁺+4e⁻→Cl⁻+2H₂O

The action of chlorine dioxide on organic materials such as those in microorganisms depends on oxidation and, therefore, alteration of proteins and RNA inside of cells.

The present invention contemplates the infusion of inert, or combustion, gases into ballast water—in order to kill harmful aquatic nuisance species by simultaneous, synergistic, inducement of (1) hypercapnia (elevated concentration of dissolved CO₂), (2) hypoxia (depressed concentration of dissolved O₂), (3) acidic pH level and (4) chlorine dioxide. As discussed previously, the inerting gases may be obtained, for example, from (i) a ship's inert gas generator, or from (ii) ship's own flue gases, or from a standard marine inert gas generator. These gases are highly noxious, having CO₂ significantly increased and O₂ significantly depleted, from normal atmospheric levels. An air-breathing animal—not only humans, but lower animals—would soon be stifled by these gases. Thus one way to think about the prophylactic action of present invention is to consider that the present invention effectively and efficiently alters the mixture of atmospheric gases, including oxygen (O₂), that normally are dissolved in ballast water in favor of, predominantly, carbon dioxide (CO₂). Aquatic marine organisms—at least of the aerobic types—can scarcely tolerate these noxious gases any better than can air-breathing animals, and a widespread and severe die-off of multiple marine organisms, is experienced in the presence of these noxious gases dissolved in sea water.

This condition of enhanced dissolved CO₂ which is of an extreme level such as strongly induces hypercapnia in marine organisms—is, in accordance with the present invention, preferably realized by infusion of a mixture gases into the seawater, which gaseous mixture is preferably enhanced in CO₂≧11% by molar volume and, more preferably, to ≧15% by molar volume. In accordance with the invention, these gases enhanced in CO₂ are preferably realized as the gaseous output of a standard shipboard inert gas generator (commonly called a Holec generator, or a Maritime Protection generator, after the major manufacturers thereof) output of which is commonly about 84% Nitrogen, 12-14% CO₂ and 2% Oxygen), and/or as a ship's own flue gases. These preferred CO₂ concentrations may be compared with, by way of example, published studies of hypercapnia in marine organisms that have generally investigated introduction of gaseous mixtures having CO₂ concentrations in the range from 0.1% to 1%. In accordance with the present invention, effective delivery of the gases high in CO₂ concentration into ballast water will be realized by bubbling these gases into ballast water mostly from the diffusers located at the bottom of the ballast water tank. However, it may be necessary to bubble the gases from the diffusers purposely located at the side and as well locations with dense and complex structures; dense and complex structures are ‘pre-disposed’ to negate adequate diffusion of inert gas in the ballast water.

The infusion of the gases enhanced in percentage CO₂ is preferably continued until dissolved CO₂ in the ballast water is raised to ≧20 ppm, and more preferably to ≧50 ppm. Dissolved CO₂ of this level serves to acidify sea water. The chemical mechanism by which enhanced dissolved CO₂ acidifies seawater is:

CO₂+H₂O.→H₂CO₃H [symbol] H⁺+HCO₃⁻

Dissolved CO₂ of the preferred levels of 20 ppm reduces the pH of seawater, which is normally 8, to acidic levels of pH 7, and, preferably, pH 6 and still more preferably pH 5.5.

This enhancement is based on the recognition that (i) aquatic nuisance species present in ship's ballast water may best be controlled by a combination of hypoxic, hypercapnic and acidic conditions within the ballast water, and that (ii) these conditions may be simultaneously economically realized by bubbling gases from an inert gas generator, and/or the flue gases of the ship, through the ballast water. The preferred levels of dissolved CO₂ i.e., preferably ≧20 ppm, and more preferably to 50 ppm), and the preferred pH levels (i.e., to pH≦7, and, preferably, pH≦6 and still more preferably pH≦5.5), have already been stated. In accordance with the present invention, the oxygen content of a gaseous mixture that infused with ballast water is preferably ≦4% O₂, and is more preferably ≦3% O₂, and this infusion of is continued until a dissolved oxygen level of, preferably, ≦1 ppm O₂ and, more preferably, ≦0.8 ppm O₂ is induced.

Important to understanding the present invention, it should be appreciated that the method of the invention is managing at least four different conditions—each of two dissolved gases, and acidity/alkalinity—all at the same time. To appreciate that the conditions are separate, and separately managed, understand to begin with that hypoxia, or lack of oxygen, implies neither hypercapnia—an excess of carbon dioxide—nor acidity—a pH less than seven. For example, oxygen present in ullage space gases and/or as a dissolved gas in ballast water may be replaced with nitrogen without appreciable effect on either (i) the dissolved carbon dioxide within, or (ii) the pH balance of, the ballast water.

Likewise, it should be understood that hypercapnia, or an excess of carbon dioxide, does not mandate hypoxia, nor an acidic pH. For example, the carbon dioxide level in the enclosed atmosphere of a submarine can, as a product of human respiration, rise to high levels but that it is “scrubbed” from the atmosphere. The build-up of CO₂ can transpire in an enclosed space nonetheless that the atmosphere may constantly contain copious oxygen (derived on a nuclear submarine from the electrolysis of water with electricity).

Finally, even when carbon dioxide is added to water—as it sometimes is by aquarists to promote the lush growth of aquatic plants—this augmentation of dissolved CO₂ gas need not result in decreased pH (increased acidity) of the water (by the same chemical mechanism as occurs in the present invention) if, as is often the case, any lowering of the pH level is counteracted by the addition of a chemical base such as, most commonly, lime.

One embodiment of the ballast water treatment method in accordance with the present invention consists of (i) bubbling an oxygen-depleted, CO₂-enhanced, inert gas mixture via a row of pipes (orifices at the bottom of the pipes) located at the bottom of a shore based ballast water storage tank.

The inert gas is preferably from a standard Marine inert gas generator, and is commonly composed of about 84% Nitrogen, 12-14% CO₂ and 2%-4% Oxygen. In accordance with the present invention, the ballast water is equilibrated with gases from the inert gas generator. As a result, the water will become hypoxia, will contain CO₂ levels much higher than normal, and the pH will drop from the normal pH of seawater (pH 8) to approximately pH 6.

Therefore, in one of its aspects the present invention is embodied in a method of killing aquatic nuisance species in ship's ballast water. The base method consists simply of infusing carbon dioxide into the ship's ballast water at a level effective to kill aquatic nuisance species by hypercapnia, with effectivity of killing harmful organisms is enhanced by adding chlorine dioxide. The infusing is preferably with a gaseous mixture of 11% carbon dioxide by molar volume. This infusing with the gaseous mixture of 11% carbon dioxide preferably transpires until the ballast water is hypercapnic to 5 ppm dissolved carbon dioxide. This infusing preferably transpires by bubbling the gaseous mixture through the ballast water. The base method is preferably expanded, or enlarged, to include concurrently depleting oxygen in the ship's ballast water at a level effective to kill aquatic nuisance species by hypoxia.

In this expanded method the infusing is preferably like as in the base method, with the depleting preferably transpiring by substitution of gases, including oxygen gas dissolved in the ballast water, with a gaseous mixture of 4% oxygen. This depicting with a gaseous mixture of 4% oxygen preferably transpires until the ballast water is hypoxic to 1% ppm dissolved oxygen.

In either the base, or the expanded, method, the infusing and/or the depleting may be, and preferably is, accompanied by acidifying of the ship's ballast water at a level effective to kill aquatic nuisance species by enhancing with Chlorine Dioxide. This acidifying is a consequence of the infusing where, as is preferred, the infusing is with a gaseous mixture of 11% carbon dioxide by molar volume. In this case the acidifying is then concurrently realized by the chemical reaction: CO₂+H₂O.→H₂CO₃ [symbol] H⁺+H⁺CO₃⁻

More particularly, the infusing with the gaseous mixture of 11% carbon dioxide preferably transpires until both (1) the ballast water is hypercapnic to 20 ppm carbon dioxide, and (2) the same ballast water is acidic to pH 7. As before, the infusing and, consequent to the infusing, the acidifying preferably transpires by bubbling the gaseous mixture through the ballast water. Likewise that the infusing (of CO₂) preferably transpires the same in the basis, and in the extended, methods, so also does the depleting (of O₂) preferably transpire the same even when the consequence of the depleting is measured in the acidification, or the lowering of the pH of the ballast water, instead of, or in addition to, the inducing of hypercapnic and/or hypoxia conditions. Further likewise, the depleting (of CO₂) and/or the depleting (of O₂) preferably transpires by the same bubbling process, when the consequence of the depleting is measured in the acidification, or the lowering of the pH of the ballast water, instead of, or in addition to, the inducing of hypocapnic and/or hypoxia conditions.

In simple terms, the process steps of the present invention are consistent, and synergistic. Everything works together, in concert and to the same end: the killing of aquatic nuisance species in ship's ballast water. Each one of the organism's three killing ‘guns’ i.e. hypercapnia, hypoxia, and low pH have their own unique capability to ‘kill’ organisms, but it does not appear that any art prior addresses that synergistic effects of all three elements or ‘guns’ simultaneously.

The permeated gaseous mixture is preferably the output of a marine inert gas generator. This gaseous mixture that is output from a marine inert gas generator consists essentially of nitrogen in the range from 87% to 84% mole percent, carbon dioxide in the range from 14% to 11% mole percent, and oxygen in the range from 2% to 4% mole percent.

Regardless of the particular ratios of the gaseous components of the gaseous mixture, the permeation is most preferably continued until the ship's ballast water is hypoxic to ≦0.8 ppm oxygen, hypercapnic to ≧50 ppm carbon dioxide, and acidic to pH≦6.

What is claimed is:

1. A method of purging for retarding corrosion in the interior of steel ballast tanks of a double hull tanker, the method comprising:
starting an initial flow of a compressed inert gas into the bottom ballast tank through a plurality of evenly distributed diffuser nozzles discharging downward onto the floor of the bottom ballast tank before the ballast water is fully pumped out of the ballast tank;
progressively increasing the flow of inert gas into the side walls of the ballast tank through a plurality of evenly distributed diffuser nozzles discharging downward;
measuring the oxygen content of the venting gases escaping the ballast tank;
ceasing flow of the inert gas when the oxygen content of the venting gases substantially equals the oxygen concentration of the inert gas.

2. The method of claim 1 wherein the inert gas is composed of approximately 84% N₂, 12-14% CO₂ and 2-4% O₂.

3. The method of claim 1 wherein a small flow of the inert gas is maintained through the array of diffusers during voyages of the ship to provide a draft pressure inside the ballast tank to preclude the influx of air;

4. The method of claim 1 wherein the compressed inert gas is cooled to near ambient conditions prior to entering the array of diffusers inside the ballast tank.

5. A method of reducing biological activity in a ship's ballast water comprising sparging a gas containing elevated levels of CO₂ into a ship's ballast water through a plurality of evenly distributed diffuser nozzles inside the ballast water hold tank until the level of dissolved CO₂ within the ballast water reaches hypercapnia conditions that are intolerable to marine organisms.

6. The method of claim 5 wherein the sparging gas flow is maintained until the level of dissolved O₂ within the ballast water reaches hypoxia conditions that are intolerable to marine organisms.

7. The method of claim 5 wherein the sparging gas flow is maintained until the dissolved CO₂ content lowers the pH of the ballast water to conditions that are intolerable to marine organisms.

8. The method of claim 5 wherein the sparging gas is composed of approximately 84% N₂, 12-14% CO₂ and 2-4% O₂.

9. The method of claim 5 wherein the biological activity within the ballast water is further reduced by mixing a stream of ClO₂ into the sparging gas until the chlorine level in the ballast water reaches levels intolerable to marine organisms.
